(19) United States
(12) Patent Application Publication
(10) Pub. No.: US 2005/0082725 A1
(43) Pub. Date: Apr. 21, 2005

(54) Production of improved zirconia products

(76) Inventor: David P. Lieb, Colo. Springs, CO (US)

Correspondence Address: DAVID BENNETT ESQ., 7, THOMAS RICE DRIVE, WESTBOROUGH, MA, 01581, US

(21) Appl. No.: 10/805,839

(22) Filed: Mar. 22, 2004

Related U.S. Application Data
(60) Provisional application No. 60/511,705, filed on Oct. 17, 2003.

(51) Int. Cl. C04B 35/48

(52) U.S. Cl. 264/604

(57) ABSTRACT

The invention provides a process for reducing the color of HIPed components made from stabilized zirconia.

### RELATED APPLICATION

This Application claims an invention previously described in Provisional Application 60/511,705 filed Oct. 17, 2003 by the same Inventor.

### BACKGROUND TO THE INVENTION

The use of stabilized zirconia in the production of industrial components has become extensive because of the durability of the material, its strength and resistance to abrasion. Zirconia has two important crystalline forms: the monoclinic form which is stable at ambient temperatures; and the tetragonal form which is stable only at high temperatures. The phase diagram for zirconia phase transitions, including the monoclinic/tetragonal transition, describes the transition temperatures under relevant conditions. Zirconia used in the form of ceramic components are most preferably stabilized in the tetragonal form to avoid the consequences of phase change upon cycling above and below the above temperature and this can be accomplished used stabilizers such as yttria, rare earth metal oxides and alkaline earth metal oxides. By far the most commonly used stabilizer is yttria, incorporated in to the zirconia in an amount of about 2 to 5% by weight. Zirconia stabilized with yttria, (which are the most important engineering zirconias), are commonly known as Y-TZP (which stands for yttria stabilized tetragonal zirconia, polycrystalline). They contain 3 mole % of yttria or slightly less. Most Y-TZP powders are made by chemical means but they can also be manufactured by bulk melting of a mixture of zirconia and yttria and then grinding the product to a fine powder with a particle size of one micron or less.

In addition to the stabilizer there may be some impurities depending on the source of the zirconia used. Where the intended purpose is for surgical implant operations, extremely low impurity levels totaling less than 0.5% by weight are tolerated. However for general industrial applications cheaper sources of zirconia carrying higher levels of impurity such as oxides of silicon, iron, calcium and titanium, are used. Such materials are used to produce zirconia dies, can tools, nozzles and the like and give rise to certain problems when used to form such components.

The forming process involves mixing the powder with a temporary binder and then shaping the mixture to the desired shape in a mold. The temporary binder can be any material which will enable the powder particles to be shaped and yet will burn out leaving essentially no remainder during the forming process. This comprises sintering the crystalline material to closed porosity at about 1300-1500 degrees Centigrade for about an hour. After this, to increase the density to essentially the theoretical density of the material, the shaped component is subjected to isostatic argon pressure of about 300 MPa, (that is, the material is “HIPed”), at a similar temperature. This is to give the component the desired optimum physical properties. The HIPing cycle needs to be prolonged to permit adequately uniform heat transfer and could extend to one or two days in an industrial process.

The HIPing process produces excellent physical properties but it also results in a certain darkening of the original white color of the component. This may be the result of some slight degree of reduction of the zirconia but is predominantly thought to flow from reduction of some of the concomitant impurities. The amount of this darkening depends largely on the levels of impurity in the zirconia. In the purest zirconias permitted for surgical implant applications, this darkening may result in the development of a light grey color but in the case of the more commonly used zirconias for general commercial applications, the discoloration can leave the component with a dark brown or even black appearance. This may not be a problem for some applications but if it is necessary to give the finished component an identifying code, symbol, bar code or the like, this is typically done by laser engraving which produces black alphanumeric or other symbols on the component. However such identifier symbols may be difficult to read under commercial use applications except under close inspection under high intensity light because of the color of the background. In some applications such as can tools, where the specific tool used depends on the specific stage of the can formation in which it is to be used, this identifier visibility comprises a significant problem. The laser engraved alphanumeric characters can be made larger and deeper to improve their visibility but this risks causing laser-induced micro-cracking of the component which may lead to subsequent failure when under stress.

There is an added problem arising in the specific use as a can tool. In this application the can tool has internal shoulders against which metal presses during the can formation process. Metal can build up on these shoulders after repeated cycles and this must be polished off to prolong the life of the tool. However with a darkened tool this build-up is easily overlooked.

It is therefore very important to the industrial use of stabilized zirconia components that this discoloration problem be solved by a process that does not involve the expense of moving to the use of highly pure and expensive sources of zirconia.

This discoloration problem has now been addressed and solved by the present invention.

### GENERAL DESCRIPTION OF THE INVENTION

It has now been discovered that the color of a component formed by HIPing a stabilized zirconia can be reduced in intensity by subjecting the component to a temperature of from 1000 to 1300 degrees Centigrade for from 45 minutes to two hours in air. In preferred processes, which are sometimes referred to as “thermal bleaching”, the temperature used is from about 1050 to 1200 degrees Centigrade. The optimum time of heating depends on the temperature used with longer times being used with lower temperatures. At preferred temperatures however the preferred time of heating is an hour.

The degree of reduction in discoloration depends largely on the amount and type of impurity present in the original zirconia, though a minor component may result from any minor amount of residue left behind from the temporary binder that is essentially removed during sintering. The greatest benefit of thermal bleaching is obtained where the amount of impurity exceeds the “up to 0.5% by weight” permitted under ASTM F1873-98 stabilized zirconias used for surgically implanted devices. As indicated above the amount of impurity present for zirconias in which the present invention has greatest utility is above 0.5% by weight and can be as much as 2% by weight.

The thermal bleaching process is carried out in air but it can also be carried out in oxygen or other oxidizing atmosphere.

### DETAILED DESCRIPTION OF THE INVENTION

The invention is now further described in detail with reference to the following Example which is for the purpose of illustration only and is not intended to imply any limitation on the essential scope of the invention.

### EXAMPLE 1

This example describes the production of a can tool from a stabilized zirconia. A HIPed stabilized zirconia in the form of a white powder was used to produce a can tool. Commercial samples of this powder are understood typically to contain 4.03% by weight of yttria and the following impurities at the levels indicated:

| | |
|---|---|
| Titania | 0.12% by weight |
| Iron oxide | 0.07% by weight |
| Calcium oxide | 0.09% by weight |
| Silica | 0.05% by weight |
| Magnesium oxide | 0.06% by weight |
| Aluminum oxide | 0.08% by weight |
| Sodium oxide | 0.06% by weight |

This powder was mixed with as a temporary binder and shaped into the form of the desired can tool before being sintered to closed porosity at a temperature of 1300 to 1500 degrees Centigrade. The ramp up to the sintering temperature was adjusted to allow for burn out of the temporary binder at around 600 degrees Centigrade before continuing to sintering conditions. This part of the process took about an hour.

The sintered component was then HIPed under an argon pressure of 300 MPa with temperatures of 1300 to 1500 degrees Centigrade being used. This HIPing took a total cycle time of two days. At the end of that time the can tool was dark brown. Laser engraved alphanumeric identifiers on such a product were hard to read under plant conditions.

The can tool was then heated in air to a temperature of 1100 degrees Centigrade over a period of an hour and was then allowed to cool. The final product had faded to a light tan color and idicia laser engraved on the surface could be easily read.

1. A process for reducing the color of a component made by sintering and HIPing stabilized zirconia powder which comprises heating the component in an oxidizing atmosphere at a temperature of from 1000 to 1300 degrees Centigrade for a period of at least 45 minutes.

2. A process according to claim 1 where in the stabilized zirconia powder comprises impurities selected from the oxides of at least iron, titanium and calcium in an amount that is greater than 0.5% by weight.

3. A process according to claim 1 in which the component is heated for a period of from one hour to one and one half hours at a temperature of 1050 to 1150 degrees Centigrade.

4. A process according to claim 1 in which the component is a can tool.

5. A process according to claim 1 in which the color-reduced component is then laser-engraved with alphanumeric or bar-code characters.
